(19) United States
(12) Patent Application Publication
(10) Pub. No.: US 2025/0388118 A1
(43) Pub. Date: Dec. 25, 2025

(54) POWER ELECTRONICS PROTOCOL TRANSLATOR APPARATUS FOR FAST ELECTRIC VEHICLE CHARGERS

(71) Applicant: HAMAD BIN KHALIFA UNIVERSITY, Doha (QA)

(72) Inventors: Ali Sharida, Doha (QA); Haitham Abu-Rub, Doha (QA); Naheel F. Kamal, Doha (QA); Sertac Bayhan, Doha (QA)

(21) Appl. No.: 19/234,454

(22) Filed: Jun. 11, 2025

Related U.S. Application Data
(60) Provisional application No. 63/662,852, filed on Jun. 21, 2024.

(51) Int. Cl. B60L 53/68; B60L 53/14; B60L 53/66; H04L 67/12; H04L 69/08

(52) U.S. Cl. CPC B60L 53/68; B60L 53/14; B60L 53/66; H04L 69/08; H04L 67/12

(57) ABSTRACT

Example systems, methods, and apparatus are disclosed herein for a power electronics protocol translator apparatus for electric vehicle chargers. The power electronics protocol translator apparatus for electric vehicles, wherein the power electronics protocol translator apparatus is in communication with a charge controller and a power electronics system. The system includes an electric vehicle, a charge controller, a power electronics system, and an power electronics protocol translator in communication with the charge controller and power electronics system. The method includes detecting a module utilized in a charge controller and a power electronics system, translating messages from the charge controller and power electronics system, and sending the messages.

### CROSS-REFERENCE TO RELATED APPLICATION

The present disclosure claims priority to U.S. Provisional Patent Application 63/662,852 having a filing date of Jun. 21, 2024, the entirety of which is incorporated herein.

### BACKGROUND

Fast electric vehicle chargers consist of four main systems: a charge controller, a power electronics system, an electric vehicle, and a server. The charge controller receives reference charging parameters from the electric vehicle through the power line communication system. The charge controller transmits these parameters to the power electronics system and keeps monitoring the physical measurements acquired through the power electronics system. At the same time, the charge controller keeps updating these measurements inside the server periodically through an open-charge point protocol (OCPP).

A significant challenge with commercial fast electric vehicle chargers is that each part of the systems is designed by different manufacturer. Although there are many standards for regulating power ratings, safety, protection, and communication between electric vehicle and the charge controller, there is no single standard for the communication between the charge controller and the power electronics system. Due to the lack of such standard, each power electronics system manufacturer designs a specific communication system for their products. This introduces a new challenge of how to regulate and standardize the communication different power electronic modules and charge controllers, especially when they use different communication systems.

Recently, companies have started to standardize this process and have proposed to use a new communication protocol called power electronics protocol (PEP), which depends on CAN-Bus protocol. PEP shows multiple advantages over other communication protocols for electric vehicle chargers. However, most of the commercial products have not yet adopted the PEP as it is difficult to change the communication systems for most, if not all, products. This challenge increases the complexity of adopting the PEP as a standard to achieve the communication between charge controllers and power electronics systems.

A need therefore exists for a power electronics protocol translator apparatus for fast electric vehicle chargers.

### SUMMARY

Example systems, methods, and apparatus are disclosed herein for a power electronics protocol translator apparatus for fast electric vehicle chargers.

In light of the disclosure herein, and without limiting the scope of the invention in any way, in an aspect of the present disclosure, which may be combined with any other aspect listed herein unless specified otherwise, a system for translating power electronics protocol for an electric vehicle includes a charge controller, a power electronics system, and a power electronics protocol translator in communication with the charge controller and the power electronics system. The power electronics protocol translator is configured to detect a module utilized in the charge controller and the power electronics system; translate a first message from the charge controller to a device-specific protocol; translate a second message from the power electronics system; send the first message to the power electronics system; and send the second message to the charge controller.

In an aspect of the present disclosure, which may be combined with any other aspect listed herein unless specified otherwise, the electric vehicle is in communication with a charge controller.

In an aspect of the present disclosure, which may be combined with any other aspect listed herein unless specified otherwise, the electric vehicle and the charge controller communicate over a charging cable.

In an aspect of the present disclosure, which may be combined with any other aspect listed herein unless specified otherwise, the system further comprises an online monitoring system.

In an aspect of the present disclosure, which may be combined with any other aspect listed herein unless specified otherwise, the charge controller is in communication with the online monitoring system.

In an aspect of the present disclosure, which may be combined with any other aspect listed herein unless specified otherwise, the charge controller and online monitoring system communicate via open-charge point protocol.

In an aspect of the present disclosure, which may be combined with any other aspect listed herein unless specified otherwise, the charge controller and power electronics protocol translator communicate via a power electronics protocol.

In an aspect of the present disclosure, which may be combined with any other aspect listed herein unless specified otherwise, a power electronics protocol translator apparatus for electric vehicles is in communication with a charge controller and a power electronics system. The power electronics protocol translator apparatus is configured to detect a module utilized in the charge controller and the power electronics system; translate a first message from the charge controller to a device-specific protocol; translate a second message from the power electronics system; send the first message to the power electronics system; and send the second message to the charge controller.

In an aspect of the present disclosure, which may be combined with any other aspect listed herein unless specified otherwise, a method for using a power electronics protocol translator apparatus for electric vehicle chargers includes detecting a module utilized in a charge controller and a power electronics system; translating a first message from the charge controller to a device- specific protocol; translating a second message from the power electronics system; sending the first message to the power electronics system; and sending the second message to the charge controller.

In an aspect of the present disclosure, which may be combined with any other aspect listed herein unless specified otherwise, detecting the module includes detecting a baud rate.

In an aspect of the present disclosure, which may be combined with any other aspect listed herein unless specified otherwise, detecting the module includes identifying headers.

In an aspect of the present disclosure, which may be combined with any other aspect listed herein unless specified otherwise, detecting the module includes identifying packets.

In an aspect of the present disclosure, which may be combined with any other aspect listed herein unless specified otherwise, failure to detect the module results in an error message.

In an aspect of the present disclosure, which may be combined with any other aspect listed herein unless specified otherwise, failure to detect the module results in enabling a manual module selection.

In light of the present disclosure and the above aspects, it is therefore an advantage of the present disclosure to provide users with a system, method, and apparatus for a power electronics protocol translator apparatus for fast electric vehicle chargers.

It is another advantage of the present disclosure to provide a communication system between a charge controller and a power electronics system of electric vehicle chargers.

Additional features and advantages are described in, and will be apparent from, the following Detailed Description. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE DRAWINGS

FIG. 1 illustrates a block diagram of the translation system including an electric vehicle, a charge controller, a server, a power electronics system, and a translator, according to an example embodiment of the present disclosure.

FIG. 2 is an image of an exemplary embodiment of the translation system, according to an example embodiment of the present disclosure.

FIG. 3 is a close-up image of the charge controller and translator of the translation system of FIG. 2, according to an example embodiment of the present disclosure.

FIG. 4 is a top view image of the charge controller of the translation system of FIG. 2, according to an example embodiment of the present disclosure.

FIG. 5 are images of the power electronics system of the translation system of FIG. 2, according to an example embodiment of the present disclosure.

FIG. 6 is a top view image of the translator of the translation system of FIG. 2, according to an example embodiment of the present disclosure.

FIG. 7 illustrates a flowchart for the proposed translator for the systems, methods, and apparatus disclosed herein, according to an example embodiment of the present disclosure.

### DETAILED DESCRIPTION

Systems, methods, and apparatus are disclosed herein for a power electronics protocol translator apparatus for electric vehicle chargers.

While the example systems, methods, and apparatus are disclosed herein for a power electronics protocol translator apparatus for electric vehicle chargers, it should be appreciated that the systems, methods, and apparatus may be operable for other applications. For instance, the systems, methods, and apparatus disclosed herein may be operable in charging applications for other electronic systems and/or renewable energy storage solutions.

The systems, methods, and apparatus disclosed herein propose a power electronics protocol translator apparatus for fast electric vehicle chargers. As communication protocols in existing electric vehicle charger's power modules vary, the systems, methods, and apparatus disclosed herein provide solutions for interfacing power electronics protocol with commercial protocols in fast electric vehicle chargers. The system addresses the lack of standardized communication protocols between different electric vehicle charger components by automatically identifying a source protocol from both a charge controller and a power electronics system, converting it to a power electronics protocol (PEP), and translating PEP into any local communication protocol. The systems, methods, and apparatus disclosed herein are flexible for use with a wide range and types of power electronic modules.

Overall, the systems, methods, and apparatus disclosed herein can be used for industrial and commercial fast electric vehicle chargers' power electronic modules to solve the problem of communication protocols heterogeneity and incompatibility. The systems, methods, and apparatus disclosed herein address the communication problems between a charge controller and power electronics system, address the lack of communication standards, provide low-cost and reliability requirements for industrial and commercial applications, and eliminates the need for development costs for manufacturers.

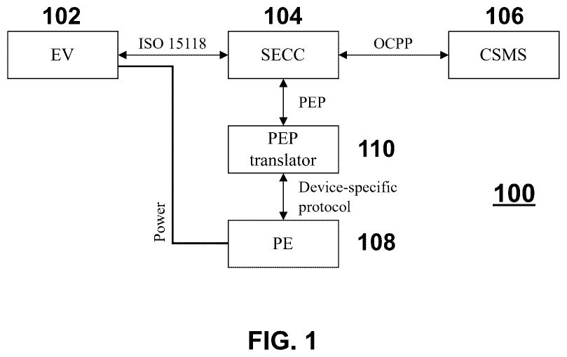

Referring now to FIG. 1, a translation system 100 includes an electric vehicle 102, a charge controller 104, a server 106, a power electronics system 108, and a power electronics protocol translator 110.

As used herein, an electric vehicle 102, or EV, is a type of vehicle that utilizes an electric motor powered by energy stored in rechargeable battery systems. The battery system typically comprises lithium-ion cells, known for their high energy density and efficiency. Electric vehicles are equipped with advanced charging capabilities, allowing for the replenishment of the battery system through various charging methods, including standard AC charging, fast DC charging, and regenerative braking systems.

As shown in FIG. 1, the electric vehicle 102 is in communication with the charge controller 104. The charge controller 104 communicates with the electric vehicle 102 by ISO 15118, a generic international standard facilitating communication between electric vehicles and chargers. In some embodiments, the charge controller 104 communicates with the electric vehicle 102 over a charging cable.

In some embodiments, the charge controller 104 is a supply equipment communication controller (SECC). The charge controller 104 may be adapted to run a variety of application programs, access and store data, including accessing and storing data in the associated databases such as the charging station management server 106, and enable one or more interactions as described herein. Typically, the charge controller 104 is implemented by one or more programmable data processing devices. The hardware elements, operating systems, and programming languages of such devices are conventional in nature, and it is presumed that those skilled in the art are adequately familiar therewith.

For example, the charge controller 104 may be a single board computer (SBC) or a microcontroller implementation of a central control processing system utilizing a central processing unit (CPU), memory, and an interconnect bus. The CPU may contain a single microprocessor, or it may contain a plurality of microprocessors for configuring the CPU as a multi-processor system. The memory may include a main memory, such as a dynamic random access memory (DRAM) and cache, as well as a read only memory, such as a PROM, EPROM, FLASH-EPROM, or the like. The system may also include any form of volatile or non-volatile memory. In operation, the memory stores at least portions of instructions for execution by the CPU and data for processing in accord with the executed instructions.

The charge controller 104 supports USB, I2C, Ethernet, SPI, RS485, and RS232.

Aspects of the example systems, methods, and apparatus provided herein encompass hardware and software for controlling the relevant functions. Software may take the form of code or executable instructions for causing the charge controller 104 or other programmable equipment to perform the relevant steps, where the code or instructions are carried by or otherwise embodied in a medium readable by the charge controller 104 or other machine. Instructions or code for implementing such operations may be in the form of computer instruction in any form (e.g., source code, object code, interpreted code, etc.) stored in or carried by any tangible readable medium.

The charge controller 104 also communicates with a charging station management server 106 through an open-charge point protocol (OCPP) to enable sending and receiving instructions electronically. The communication may be wired or wireless. In some embodiments, the server 106 is an online monitoring system.

The translator system 100 includes a power electronics system 108. The power electronics system 108 communicates with the charge controller 104. The power electronics system 108 includes hardware configured to power the electric vehicle 102.

However, because the power electronics system 108 communicates with a device-specific protocol and the charge controller 104 may communicate with a separate protocol, a power electronics protocol translator 110 bridges the communication gaps between the charge controller 104 and the power electronics system 108. In this regard, the translator 110 utilizes different protocols based on CAN-Bus to facilitate data exchange between the charge controller 104 and the power electronics system 108. When data is able to be exchanged between the charge controller 104 and the power electronics system 108, the charge controller 104 is able to control both the power electronics system 108 and the translator 110, monitor their measurements, and specify the references and limits of the components.

The translator 110 employs a power electronics protocol (PEP), leveraging CAN-Bus for communication. The translator 110 facilitates the conversion between the PEP and the vendor-specific communication systems of the power electronics system 108. In this regard, PEP overcomes the lack of standardized communication between a charge controller 104 and power electronics system 108.

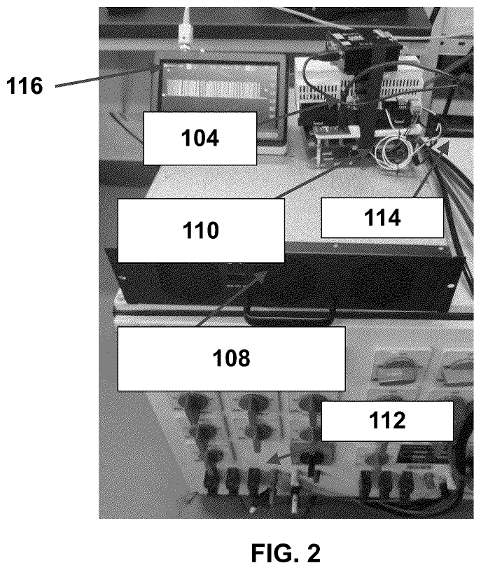

The software within the translator 110 facilitates the encoding and decoding of messages between the charge controller 104 and power electronics system 108. It is implemented as an efficient modular C library. The modular design allows for easy maintenance, updates, and expansions of functionality to support wide range of power electronics systems 108 as described herein. The library includes components for hardware interaction with the CAN-Bus interface. In some embodiments, such as those described in FIGS. 2 to 6, the implemented library is validated on a simulated environment and in the translator 110.

FIGS. 2 to 6 illustrate an embodiment of an experimental lab-scale system of FIG. 1 designed for testing and validation of the communication protocol translation. The system of FIGS. 2 to 6 includes software and hardware. The hardware consists of a charge controller 104, a power electronics system 108, a power electronics protocol translator 110, a load device 112, and a CAN-Bus line 114. The software consists of a module identification method, translation from a general communication protocol to PEP, and translation from PEP to a device-specific protocol. In some embodiments, the translation system 100 further includes an oscilloscope 116 to monitor the processes of the translation system 100.

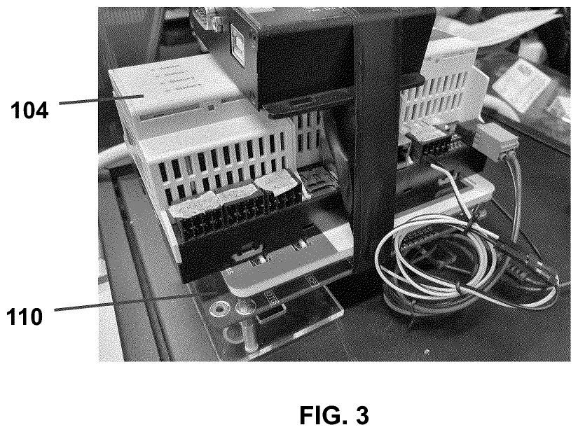

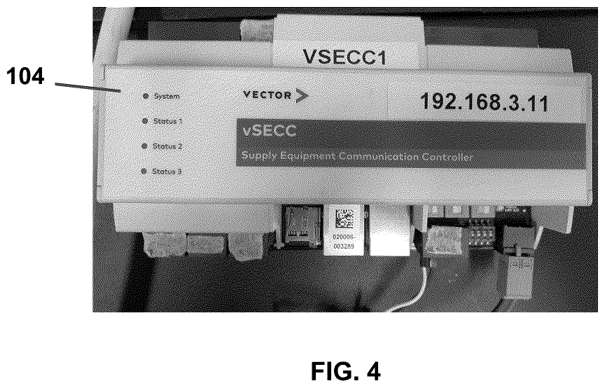

The charge controller 104 of FIGS. 2 to 6 is a vSECC communication controller manufactured by Vector which is used as an off-the-shelf industrial electric vehicle charger communication controller. It will be appreciated that the vSECC communication controller described herein is purely exemplary and other controllers may be added or omitted in the translation system 100 in other embodiments. FIG. 3 illustrates an isometric view of the charge controller 104 with the translator 110. FIG. 4 illustrates a top view of the charge controller 104.

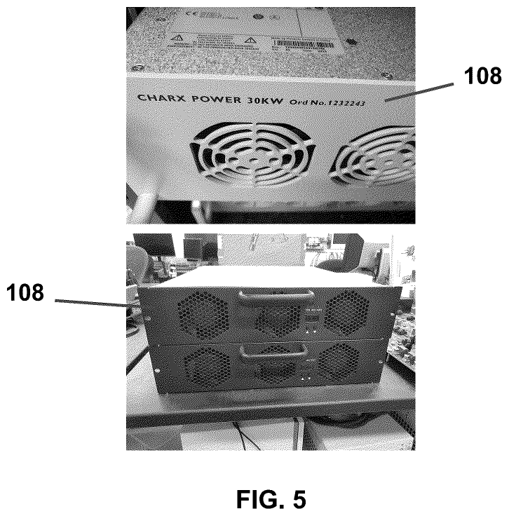

The power electronics system 108 of FIGS. 2 to 6 is a MXR100030B power module, manufactured by Maxwell Technologies Co. FIG. 5 illustrates closer views of the power electronics system 108. It will be appreciated that the MXR100030B power module described herein is purely exemplary and other power electronics systems may be added or omitted in the translation system 100 in other embodiments, including educational and commercial power electronic systems. A non-exhaustive list of other power electronics systems that may be utilized is summarized in Table 1 below. In this regard, the translation system 100 supports connecting multiple power electronic systems, supporting a wide array of baud rates and CAN-types (normal and extended).

TABLE 1

| | | Power | Input | Output | Max | |
|---|---|---|---|---|---|---|
| Manufacturer | Model | Output | Voltage | Voltage | Current | |
| Phoenix | Charx Power 30 kW | 30 kW | 340-530 VAC | 30-1000 VDC | 100 | A |
| Contact | | | | | | |
| Maxwell | MXR100030 | 30 kW | 285-475 VAC | 100-1000 VDC | 100 | A |
| Infy Power | REG1K025G | 20 kW | 260-530 VAC | 150-1000 VDC | 25 | A |
| Tonhe | TH750Q61ND-AX | 20 kW | 285-475 VAC | 200-750 VDC | 61 | A |
| Tonhe | TH40F10030C7-WT | 40 kW | 270-490 VAC | 50-1000 VDC | 134 | A |
| MIDA | UR100040SW-SiC | 40 kW | 260-530 VAC | 150-1000 VDC | 134 | A |
| Senku | TH500Q40ND-A | 30 kW | 266-494 VAC | 200-750 VDC | 50 | A |
| Machinery | | | | | | |
| MIDA | BEG1K075G | 22 kW | 285-475 VAC | 150-1000 VDC | 33.3 | A |
| Winline | UXC100040 | 40 kW | 400-850 VDC | 50-1000 VDC | 133.3 | A |

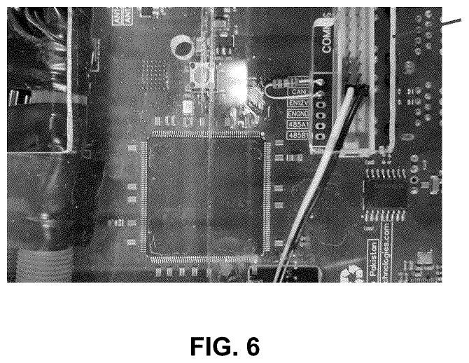

The translator 110 of FIGS. 2 to 6 is a STM32H745BI microcontroller. Common for industrial applications and chosen for its functionality and suitability in practical environments, the microcontroller is the main control broad representing the translator 110. The STM32H745BI microcontroller provides the necessary processing power for CAN-Bus communication and data conversion. FIG. 6 illustrates a close-up top view of the control board which manages the translation process between the charge controller 104 and the power electronics system 108.

It will be appreciated that the STM32H745BI microcontroller described herein is purely exemplary and other translators may be added or omitted in the translation system 100 in other embodiments. In some embodiments, more than one control board is utilized as the translator 110.

Because the embodiment of FIGS. 2 to 6 are provided in a laboratory environment, a load device 112 is utilized to provide power. The system of FIGS. 2 to 6 is configured to implement different load scenarios and DC voltages to emulate real electric vehicle charging. In this regard, the translation system 100 is compatible with industrial modules and research modules such as grid emulators, battery emulators, and programmable power supplies. In some embodiments, the power provided by the load device 112 is Chroma bidirectional DC power supply, however, it will be appreciated that other types of power supplies may be utilized in other embodiments of the translation system 100. In yet other embodiments, a cinergia AC/DC grid emulator may be utilized as the load device 112.

The translation system 100 further includes a CAN-Bus line 114 physically connecting the CAN-Bus interfaces of the charge controller 104 and the translator 110. The CAN-Bus interface includes a CAN-Bus controller and a transceiver. The CAN-Bus interface facilitates data exchange between the components of the translation system 100. The CAN-Bus line 114 can exchange information up to 1 Mbps for CAN and 8 Mbps for FD-CAN. In some embodiments, the 11-bit and 29-bit identifier formats are supported. The translation system 100 supports all CAN versions 2.X and supports both CAN and FD-CAN.

The CAN-Bus signals and communicated data are monitored to ensure valid and proper communication between involved components of the system. In some embodiments, monitoring the CAN-Bus signals and communicated data is conducted visually using an oscilloscope 116 and digitally using an external CAN-Bus to USB adapter using a connected PC.

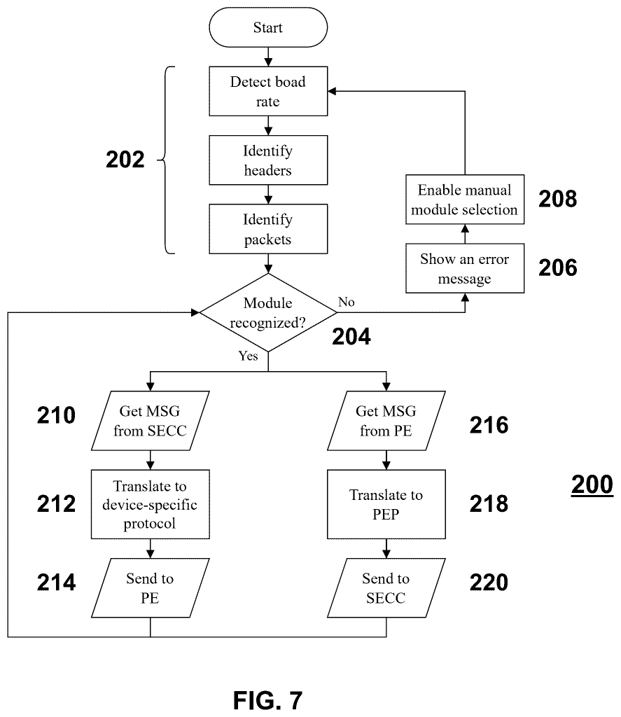

FIG. 7 illustrates a flowchart of an exemplary method 200 utilized with the above-referenced translation system 100. In step 202, a module utilized in the charge controller 104 and power electronics system 108 is detected by the translator 110. This determination is made by reviewing various parameters including: the baud rate of the power electronics system 108, the headers and addresses associated with the power electronics system 108 which are matched to known headers and addresses associated with various different protocols, and packets transmitted by the power electronics system 108. Data from manuals and technical specifications of various power electronics systems can be input into the translator 110 to assist with detection of the power electronics system 108 module.

In step 204, the translator 110 determines whether the module detected in step 202 is recognized. If it is not recognized and there is a failure to detect the module, steps 206 and 208 are performed. In step 206, an error message is shown to the user. In step 208, manual module selection is enabled. In some embodiments, steps 206 and 208 are performed over a USB connection when connected to a user PC.

If in step 204, the module is recognized by a memory of the translator, the translator 110 receives a first message from the charge controller 104 in step 210. In step 212, the first message from the charge controller 104 is translated to a device-specific protocol. In step 214, the translated first message is sent to the power electronics system 108. Similarly, in step 216, the translator 110 receives a second message from the power electronics system 108 in step 216. In step 218, the second message from the power electronics system 108 is translated to a device-specific protocol. In step 220, the translated second message is sent to the charge controller 104. Steps 210 to 220 are repeated as messages are sent by the charge controller 104 and the power electronics system 108.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller can read programming code and/or data. Many of these forms of computer readable media may be involved in carrying one or more sequences of one or more instructions to a processor for execution.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system for translating power electronics protocol for an electric vehicle, including:
a charge controller;
a power electronics system; and
a power electronics protocol translator in communication with the charge controller and the power electronics system,
wherein the power electronics protocol translator is configured to:
detect a module utilized in the charge controller and the power electronics system;
translate a first message from the charge controller to a device-specific protocol;
translate a second message from the power electronics system;
send the first message to the power electronics system; and
send the second message to the charge controller.

2. The system of claim 1, wherein the electric vehicle is in communication with a charge controller.

3. The system of claim 2, wherein the electric vehicle and the charge controller communicate over a charging cable.

4. The system of claim 1, further comprising an online monitoring system.

5. The system of claim 4, wherein the charge controller is in communication with the online monitoring system.

6. The system of claim 5, wherein the charge controller and online monitoring system communicate via open-charge point protocol.

7. The system of claim 1, wherein the charge controller and power electronics protocol translator communicate via a power electronics protocol.

8. A power electronics protocol translator apparatus for electric vehicles, wherein the power electronics protocol translator apparatus is in communication with a charge controller and a power electronics system, wherein the power electronics protocol translator apparatus is configured to:
detect a module utilized in the charge controller and the power electronics system;
translate a first message from the charge controller to a device-specific protocol;
translate a second message from the power electronics system;
send the first message to the power electronics system; and
send the second message to the charge controller.

9. A method for using a power electronics protocol translator apparatus for electric vehicle chargers, including:
detecting a module utilized in a charge controller and a power electronics system;
translating a first message from the charge controller to a device-specific protocol;
translating a second message from the power electronics system;
sending the first message to the power electronics system; and
sending the second message to the charge controller.

10. The method of claim 9, wherein detecting the module includes detecting a baud rate.

11. The method of claim 9, wherein detecting the module includes identifying headers.

12. The method of claim 9, wherein detecting the module includes identifying packets.

13. The method of claim 9, wherein failure to detect the module results in an error message.

14. The method of claim 9, wherein failure to detect the module results in enabling a manual module selection.
